(19) United States
(12) Patent Application Publication
(10) Pub. No.: US 2016/0148715 A1
(43) Pub. Date: May 26, 2016

(54) CONDUCTIVE CELLULOSE NANOCRYSTALS, METHOD OF PRODUCING SAME AND USES THEREOF

(71) Applicant: CELLUFORCE INC., Montréal (CA)

(72) Inventors: Xiuyun WU, Kitchener (CA); Kam Chiu TAM, waterloo (CA); Richard BERRY, Notre-Dame-de-L'lle Perrot (CA); Aiping YU, Waterloo (CA)

(21) Appl. No.: 14/899,304

(22) PCT Filed: Jun. 17, 2014
(86) PCT No.: PCT/CA2014/050570

§ 371 Date: Dec. 17, 2015

Related U.S. Application Data
(60) Provisional application No. 61/836,319, filed on Jun. 18, 2013.

(51) Int. Cl. H01B 1/12; H01B 13/00

(52) U.S. Cl. CPC H01B 1/124; H01B 1/127; H01B 13/0026

(57) ABSTRACT

The present disclosure provides a core-shell nanocomposite material comprising an intrinsically conductive polymer (ICP) polymerized on the surface of oxidized cellulose nanocrystals (CNCs) as well as synthesis for preparing same and its use thereof in various applications.

### FIELD OF THE DISCLOSURE

The present disclosure provides a core-shell nanocomposite material comprising an intrinsically conductive polymer (ICP) polymerized on the surface of oxidized cellulose nanocrystals (CNCs) as well as synthesis for preparing same and its use thereof in various applications.

### BACKGROUND OF THE DISCLOSURE

Cellulose Nanocrystals (CNCs) extracted from wood fibers by acid hydrolysis are rod-like crystals with diameters of 10-20 nm and lengths of around 200-400 nm. The attractive features are: (i) it is stronger than steel yet incredibly light, (ii) high aspect ratio and specific surface area, (iii) enriched surface active groups, (iv) biodegradability, (v) abundance etc. This makes CNC a promising structural nanomaterial (as reinforcing agents), or functional nanomaterials for the fabrication of other functional nanocomposites.

ICPs have demonstrated their usefulness in a wide variety of applications, such as sensors, anti-static/electromagnetic interference shielding, organic light-emitting diode (OLED), supercapacitors, etc. due to their superior physical and chemical properties (Lange, U.; Roznyatovskaya, N. V.; Mirsky, V. M., Analytica chimica acta 2008, 614 (1), 1-26; Li, C.; Bai, H.; Shi, G., Chemical Society reviews 2009, 38 (8), 2397-409). However, the inherent problems with ICPs such as low solubility, intractable phase, poor mechanical properties make them difficult to process into useful products (Schultze, J. W.; Karabulut, H., Electrochimica Acta 2005, 50 (7-8), 1739-1745). To overcome this drawback, attempts have been made to synthesize conductive polymers on a substrate. An example of this is in the presence of carbon nanotube (CNT), however the high cost of CNT has become a serious hindrance for its wide application.

Two widely used methods for making ICP hybrid materials are in-situ chemical polymerization and electrochemical polymerization, although the latter technique is not suitable for large-scale production. Though many wood/ICP hybrid materials have been fabricated via chemical polymerization (Huang, J.; Ichinose, I.; Kunitake, T., Chemical communications 2005, (13), 1717-9; Sasso, C.; Zeno, E.; Petit-Conil, M.; Chaussy, D.; Belgacem, M. N.; Tapin-Lingua, S.; Beneventi, D., Macromolecular Materials and Engineering 2010, 295 (10), 934-941; R. V. Gregory, W. C. K. a. H. H. K., Synthetic Metals, 1989, 28, C823 C835; WO 2011/140658) they are mostly achieved by blending conductive polymer into the network of cellulose fibers in the form of films, hydrogels, or cakes with low conductivity and poor processibility.

### SUMMARY OF THE DISCLOSURE

In one aspect, there is provided a core-shell conductive polymer/cellulose nanocrystal composite comprising cellulose nanocrystals as the core, and conductive polymer coating as the shell.

In a further aspect, there is provided a method of preparing the intrinsically conductive polymer/cellulose nanocrystal composite as defined herein, said method comprising the steps of:

dispersing oxidized cellulose nanocrystals in a mixed solution of acid/alcohol;

mixing a monomer of said intrinsically conductive polymer with said oxidized cellulose nanocrystals;

polymerizing said monomer; and

isolating said conductive polymer/cellulose nanocrystal.

In a further aspect, there is provided a noble metal/ICP/cellulose nanocrystal hybrid material comprising:
the conductive polymer/cellulose nanocrystal composite as defined herein, and
noble metalnanoparticles deposited on said composites, wherein said noble metalnanoparticles have a diameter of less than about 10 nm.

In a further aspect, there is provided a method to prepare a noble metal-ICP-cellulose nanocrystal hybrid material as described herein, the method comprising:
dispersing the conductive polymer/cellulose nanocrystal composite as defined herein;
adding a noble metal salt to the dispersion and allowing reaction;
recovering said noble metal-ICP-cellulose nanocrystal hybrid material.

### BRIEF DESCRIPTION OF THE DRAWINGS

Embodiments will now be described, with reference to the drawings, in which:

FIG. 1 shows an example outlining the procedures for preparing the conductive cellulose nanocrystals by forming the core-shell structure with polymer coating;

FIG. 2 shows (a) PPy/CNC solution after filtration; (b) Freeze-dried black power of PPy/NCC composite material; (c) Redispersed PPy/CNC suspension from freeze dried sample;

FIG. 3 shows the comparison between PPy/CNC suspension (left) and CNC-PPy-PSS suspension (right) kept undisturbed after 3 months;

FIG. 4 shows the TEM images of (a) Tempo-CNC and (b) PPy-coated Tempo CNC;

FIG. 5 shows the TGA curve of Tempo-CNC (green solid line) and PPy-coated Tempo CNC (red dash line);

FIG. 6 shows the FT-IR spectra of Tempo-CNC and PPy/CNC, and pure PPy;

FIG. 7 shows the conductivity measurements for PPy/CNC prepared at various Py/OH ratio of 1:1, 2:1, 4:1, 8:1, 12:1, 16:1, 25:1 and 50:1;

FIG. 8 shows the UV-Vis results for PPy/CNC prepared at various Py/OH ratio of 1:1, 2:1, 4:1, 8:1, 12:1, 16:1, 25:1 and 50:1;

FIG. 9 shows an illustration of how conductive PPy/CNC (black sheet pressed from PPy/CNC powder) can conduct electricity in a circuit to light a bulb;

FIG. 10 shows the TEM results of TEM results of Silver/PPy/CNC where the uniform decoration of silver nanoparticles was observed on the surface of PPy/CNC with a well-controlled size of less than 10 nm;

FIG. 11 shows the thermogravimetric (TGA) analysis of PPy/CNC (red line) and Silver/PPy/CNC composite;

FIG. 12 shows the photographs of the zone of inhibition test for Tempo-CNC, PPy/CNC and Silver/PPy/CNC against (a) E. coli and (b) B. subtilis bacteria;

FIG. 13 shows the minimum inhibition concentrations (MIC) and minimum bactericidal concentrations (MBC) of various antimicrobial materials (zinc oxide²⁷, titanium dioxide²⁸, copper²⁹, silicon dioxide³⁰, silver nanoparticles (circular³¹ and triangle³²) in comparison to the Ag/PPy/CNC. Percent inhibition for specific MIC values displayed on graph is included in brackets;

FIG. 14 shows CV curves of PPy/CNC (Py/OH=16) at scan rates of 0.01 V/s, 0.05 V/s and 0.1 V/s;

FIG. 15 shows (a) Setup for film drying, (b) uniform film prepared by ultrafiltration, (c) homemade electrode for measuring film resistance, (d) film resistance measurement setup;

FIG. 16 shows the film resistivity plot against the density of PPy/CNC film. The small graph shows the zoom-in curve at the end of the percolation region.

### DETAILED DESCRIPTION OF THE DISCLOSURE

Reference will now be made, and additional details describing various embodiments of the present surface-modified cellulose nanocrystals (CNCs) and an intrinsically conductive polymer. As used herein, polypyrrole (PPy) modified CNCs are referred to as PPy/CNC.

As used herein, the term “intrinsically conductive polymer” refers to organic polymer that has the ability to conduct electricity.

The CNCs herein are rod-like crystals with a mean diameter of 10-20 nm and lengths of 200-400 nm. It can practically be extracted from various sources like cotton, wood, alga etc. In this case, we used kraft-bleached pulp, which was obtained from Domtar and the CNC was produced by Celluforce Inc. (Montreal, Québec, Canada).

The PPy/CNCs herein are oxidized CNC coated with polypyrrole. Unless otherwise specified, all CNCs used to prepare PPy/CNC are oxidized CNCs at the primary hydroxyl groups using methods known in the art, for example Tempo-oxidized.

In one embodiment, there is provided a core-shell conductive polymer/cellulose nanocrystal composite comprising cellulose nanocrystals as the core, and intrinsically conductive polymer coating as the shell. In one embodiment, the conductive nanocomposite fibers are about 200-400 nm in length and the diameters of the conductive nanocomposite fibers are from around 10-20 nm.

In one embodiment, the conductive polymer of said intrinsically conductive polymer/cellulose nanocrystal composite is polypyrrole, polyaniline, polyindole, polythiophene, poly(3-methylthiophene, poly(N-methyl aniline), or poly(o-toluidine), or a mixture thereof. Preferably, the conductive polymer is polypyrrole, polyaniline, polyindole, polythiophene, poly(3-methylthiophene, poly(N-methyl aniline), or poly(o-toluidine), more preferably polypyrrole.

In one embodiment, a method is described for synthesizing electrically conductive CNCs by coating them with PPy. Usage of CNC as the substrate facilitates the linearly, well-ordered growth of conductive polymers due to the ‘templating effect (Xinyu Zhang, W. J. G., and Sanjeev K. Manohar, Journal of the American Chemical Society 2004, 126 (14), 4502-4503). It also resolves the intrinsic problem of poor mechanical strength and poor processability associated with these polymers. Meanwhile, CNCs reduce the consumption of conductive polymers by decreasing the percolation threshold (Evgeniy Tkalya, M. G., Wim Thielemans, Paul van der Schoot, Gijsbertus de With, and Cor Koning, ACS Macro Letters 2013, (2), 157-163).

There is therefore provided a method of preparing the conductive polymer/cellulose nanocrystal composite as described herein, said method comprising the steps of:

dispersing oxidized cellulose nanocrystals in a mixed solution of acid/alcohol;

mixing a monomer of said intrinsically conductive polymer with said oxidized cellulose nanocrystals;

adding a polymerization initiator to initiate polymerization of said monomer;

isolating said conductive polymer/cellulose nanocrystal.

Without being bound to theory, it is believed that the monomer is adhered to the surface of cellulose nanocrystals via hydrogen bonding interaction.

In one embodiment, the method is comprising a further step of oxidizing CNC with an oxidant, such as TEMPO, to provide said oxidized CNC.

In one embodiment of the method, said solution of acid/ethanol is acid/ethanol in said dispersing step is comprising an acid solution 1M HClO₄ and the volume ratio of HClO₄ to ethanol is 1:1.

In one embodiment of the method, said monomer, such as a pyrrole monomer, and said nanocrystals are mixed for a suitable time interval and controlled temperature, preferably for a time duration of about one hour. Preferably the temperature is from about 0 to 5 degrees.

In one embodiment of the method, said step of polymerization of said monomer is carried for a controlled time and temperature, preferably for about 24 hours, preferably at a temperature of from about 0 to 5 degrees.

In one embodiment of the method, said polymerization initiator is an oxidant. In one embodiment, said oxidant is ammonium persulfate. Preferably, said ammonium persulfate is dissolved in water and is added dropwise to the reaction mixture.

In one embodiment of the method, said step of isolating said conductive polymer/cellulose nanocrystal is comprising isolating quenching the said polymerization, for example said quenching is performed by filtration several times with Millipore water.

As described herein, the present disclosure provides a controlled synthesis of individually coated cellulose nanocrystals (CNCs) as the core and an intrinsic conductive polymer (ICP) as the shell. Conducting polymer systems include ICP such as polyaniline, polyindole, polythiophene, poly(3-methylthiophene, poly(N-methyl aniline), and poly(o-toluidine) and more preferably the ICP used is polypyrrole (PPy). The examples herein demonstrate the synthetic steps and comprise a pretreatment of CNC via Tempo-mediated oxidation; mixing the pyrrole monomers with treated-CNC in the mixture of acid/ethanol for a prescribed time; initiating the polymerization by adding an oxidant and quenching the reaction.

In a preferred embodiment, the extent of polymer coverage on CNC surface is tuned by varying the molar ratio of ICP, for example the initial pyrrole monomer (Py), to the surface hydroxyl groups (OH) on CNC. The ratios are referred to as Py/OH and the value is from 1:1 to 50:1. The resulting conductivity change of PPy/CNC associated with different PPy coatings could be tailored to a wide variety of applications.

In yet another embodiment, surfactant may be added before initiating the polymerization. The surfactant may be one of sodium dodecylbenzene sulfonate, sodium dodecyl sulfonate, toluene sulfonic acid and polystyrene sulfuric acid etc. The resulting PPy/CNC solution is homogeneous and stable for months and is suitable for applications, such as conductive coating, paints, etc.

Referring to FIG. 1, a flow chart outlining the preparation of the core-shell conductive PPy/CNC is described. In step 1, an oxidant-mediated (such as TEMPO-mediated) oxidation method was first conducted on CNC, converting the primary hydroxyl groups to carboxylate functionalities (Habibi, Y.; Chanzy, H.; Vignon, M. R., Cellulose 2006, 13 (6), 679-687). Though other oxidizing agents can also be used, TEMPO catalyst is currently the most widely used reagent for selectively oxidizing the primary hydroxyl groups of CNCs.

In step 2, CNCs are well-dispersed in aqueous mixture of acid/ethanol solution, which can be achieved by agitation via sonication and vortexing. The acid solution is comprised of sodium chloride, perchloric acid, however other acids such as HCl, HNO₃, H₂SO₄ etc. can be used. Various surfactants (such as sodium dodecylbenzenesulfonate (SDBS), polyvinylpyrrolidone (PVP), etc.) can also be added at this stage to the PPy/CNC mixture. In one example embodiment, polystyrene sulfuric acid (PSS) was added together with CNC and they are well mixed before the polymerization stage. The method can be used to prepare highly-stable, homogeneous PPy-CNC aqueous solution that is suitable for applications including conductive films, coatings, etc.

In step 3, pyrrole monomers were added and it is believed that they first attach to the surface of CNCs via hydrogen bonding. This step was achieved via vigorous magnetic stirring of the mixture solution comprising CNCs and conductive monomers. A suitable duration for this step was around 1 hour at a controlled temperature of 0 to 5 degrees.

Herein, the molar ratio of initial monomers to the surface hydroxyl groups on CNC (referred to as Py/OH) can be varied to achieve desirable polymer coverage. Different conductivity level can thus be obtained to meet the requirements of different applications.

The molar amount of surface hydroxyl group on CNC was calculated as follows:

CNC is made-up of anhydroglucose units (AGU) that possess a molecular weight of 162 g/mol and each AGU contain three hydroxyl groups. When 1 gram of CNC was used for preparing the composite material, the molar amount of hydroxyl group was 3*(1 g/162(g/mol))=0.0185 mol. However, this amount included both surface hydroxyl groups and those buried inside of CNCs. Only 20% of hydroxyl group were exposed on the surface of CNC, so the molar amount of accessible surface hydroxyl groups was 0.0185*20%=0.0037 mol. In one example implementation, the effect of the amount of monomer added on the final product was studied.

In step 4, the polymerization initiator (for example a suitable oxidant) was then added to the monomer-attached CNC system to initiate the polymerization of pyrrole. The polymerization was believed to proceed exclusively on the surface of CNC from the attached sites via hydrogen bonding. An example of suitable oxidant is ammonium persulfate. The reaction was kept under constant stirring at a controlled temperature of 0 to 5 degrees. The low temperature favors a better morphology of polymer growth and yielded a produce with a higher conductivity (Kassim, A.; Basar, Z.; Mahmud, H. N. M. E., J Chem Sci 2002, 114 (2), 155-162). The polymerization was allowed to proceed for 24 hours to achieve the conductive polymer coating.

Once the reaction was completed, to isolate the desired conductive polymer/cellulose nanocrystal, the solution can be transferred to an ultrafiltration in step 5 to remove excess oligomers and unreacted chemicals. The filtration was applied several times until the filtrate became colorless and transparent. The conductive polymer-coated CNCs can either be freeze dried into black powder, or it could be dispersed well in aqueous solution.

The CNC-PPy nanocomposite obtained in the examples below retained the structural feature (rod-like crystal) of CNCs with visible granularly grown PPy shell that confines on individual CNC surface. The NCC-PPy composite is thermally stable up to 250 degrees and displayed a high weight retention at high temperature (more than 40% up to 400 degrees). The conductivity for the prepared PPy/CNCs is as high as 4 S/cm. Cyclic voltamograms (CV) measurement of PPy/CNC being the supercapacitor electrode exhibited outstanding supercapacitor potential with the specific capacitance as high as 238 F/g.

The conductive PPy/CNC nanocomposites according to the aforementioned method are good candidates for a wide range of applications including to antimicrobial material, supercapacitor electrodes, sensors (including biosensors), reduction of noble metals, anti-static/EMI shielding materials, smart packaging etc. The experimental procedure is simple, cost-effective, and is easily adapted to large scale production. Moreover, the prepared nanocomposite material is renewable, non-toxic and environmental friendly.

In a further aspect, there is provided a silver/ICP/cellulose nanocrystal hybrid material comprising:
the conductive polymer/cellulose nanocrystal composite as defined herein, and
silver nanoparticles deposited on said composites, wherein said silver nanoparticles have a diameter of less than about 10 nm.

In one embodiment, there is provided a silver/polypyrrole/cellulose nanocrystal hybrid material comprising:
the conductive polymer/cellulose nanocrystal composite as defined herein, and

silver nanoparticles deposited on said composites, wherein said silver nanoparticles have a diameter of less than about 10 nm.

In a further aspect, there is provided a method to prepare silver-ICP-cellulose nanocrystal hybrid material as described herein, the method comprising:
dispersing the intrinsically conductive polymer/cellulose nanocrystal composite as defined herein;
adding a silver salt to the dispersion and allowing reaction; and
recovering said silver-ICP-cellulose nanocrystal hybrid material.

In one embodiment, there is provided a method to prepare silver-polypyrrole-cellulose nanocrystal hybrid material as described herein comprising:
dispersing the conductive polymer/cellulose nanocrystal composite as defined herein;
adding a silver salt to the dispersion and allowing reaction;
recovering said silver-polypyrrole-cellulose nanocrystal hybrid material.

Noble metal salts for use in the method for preparing noble metal/ICP/cellulose nanocrystal hybrid material are known and can be selected by the skilled practitioner. Noble metals useful in this description include without limitation Ag, Pt, Au and Cu. In one embodiment, the noble metal is a silver salt.

In one embodiment, the silver salt is silver nitrate. In one embodiment, the conductive nanocomposite solution is 0.2% wt in Milli-Q water. The silver can be reduced and deposited on the surface of said polypyrrole via redox interaction spontaneously.

In one embodiment, said silver salts are dissolved in water and added dropwise to the said conductive nanocomposite dispersion under magnetic stirring. Preferably, the duration of the reaction is 20 hours.

In one example embodiment, the as-prepared conductive CNCs are used as supercapacitor material. PPy/CNC suspension was fabricated onto a working electrode in a battery, with the electrolyte being potassium chloride (KCl).

In one embodiment, there is provided a process for fabricating supercapacitor electrode with polypyrrole/cellulose nanocrystal composite material as described herein, the process comprising:

(a) dispersing polypyrrole/Cellulose nanocrystal powder in water/ethanol (v/v=1/1) to form 1 mg/ml concentration slurry;

(b) casting the slurry on the Glass Carbon electrode (3 mm in diameter) twice with 10 μl per time and oven dried.

In a further embodiment, the as-prepared composite material was used to spontaneously reduce noble metals and the example showed one application of silver deposition. The reduction of silver proceeded via an autocatalytic process due to polypyrrole. The resulting silver-deposited PPy/CNC exhibited excellent antimicrobial effect.

### EXAMPLE 1

### Fabrication of PPy/CNC Conductive Nanocomposite

TEMPO-mediated oxidation was first conducted on CNC, converting primary hydroxyls to carboxylate functionalities (Habibi, Y., Chanzy, H., Vignon, M. R., cellulose 2006, 13 (679)). About 120 mg freeze-dried Tempo-CNC was dispersed under sonication in the mixture of 1M HClO₄ and ethanol (V/V=1/1) to produce a 0.2% wt suspension. 121.4 μL of pyrrole monomers were then added to the suspension and the mixture was transferred to a double-walled jacketed reaction vessel. The solution was vigorously stirred for 1 hour with circulation water running to maintain a temperature of between 0 to 5 degrees. The equal molar amount of ammonium persulfate (APS) dissolved in water (5 ml) was added dropwise to slowly initiate the polymerization. The color of the solution gradually turned from transparent to yellow, then to dark green and finally to black. This reaction was kept under magnetic stirring for 24 h at a temperature between 0 to 5 degrees. Finally, the reaction was quenched by several times of filtration with Millipore water.

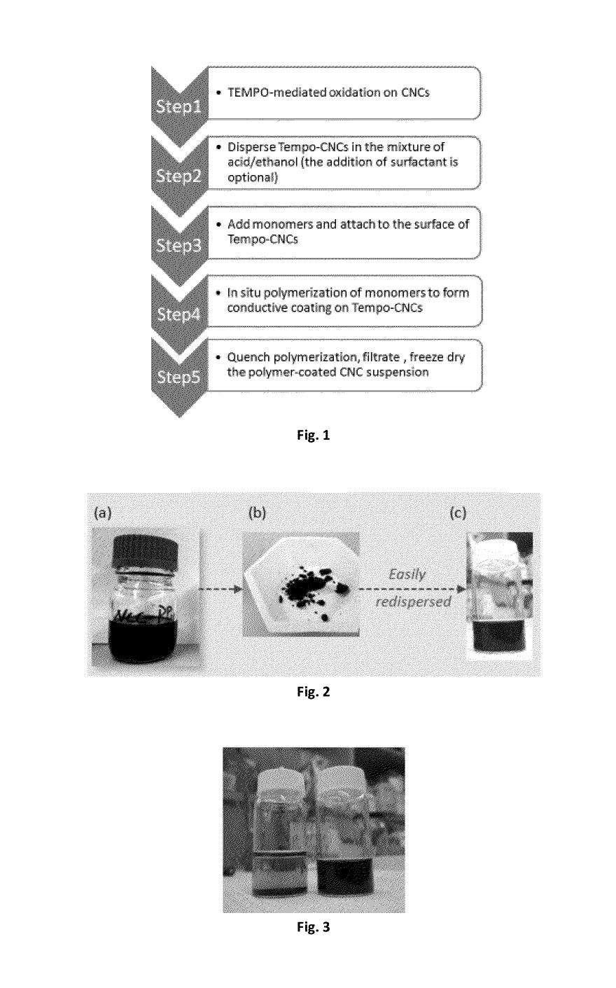

The PPy/CNC product may be freeze-dried to obtain a black powder, or it could be kept in an aqueous medium for further processing. FIGS. 2(a)-(c) show the sample product of PPy/CNC after preparation. The solution after freeze dry can be easily redispersed into aqueous medium. Freeze-dried powder of PPy/CNC may be used to make pellets for conductivity measurements. Further characterizations on PPy/CNC nanocomposite were also performed.

### EXAMPLE 2

### Fabrication of Water-Soluble PPy/CNC Composite

To make water-soluble PPy/CNC nanoparticles, poly(styrene sulfonate) (PSS) of 60 mg (for every 120 mg CNCs) was added to the mixture of pyrrole monomers and CNCs before being transferred into the jacketed reaction vessel. The subsequent experimental procedures are identical to that described in example 1. The resulting product is referred below as PSS/PPy/CNC.

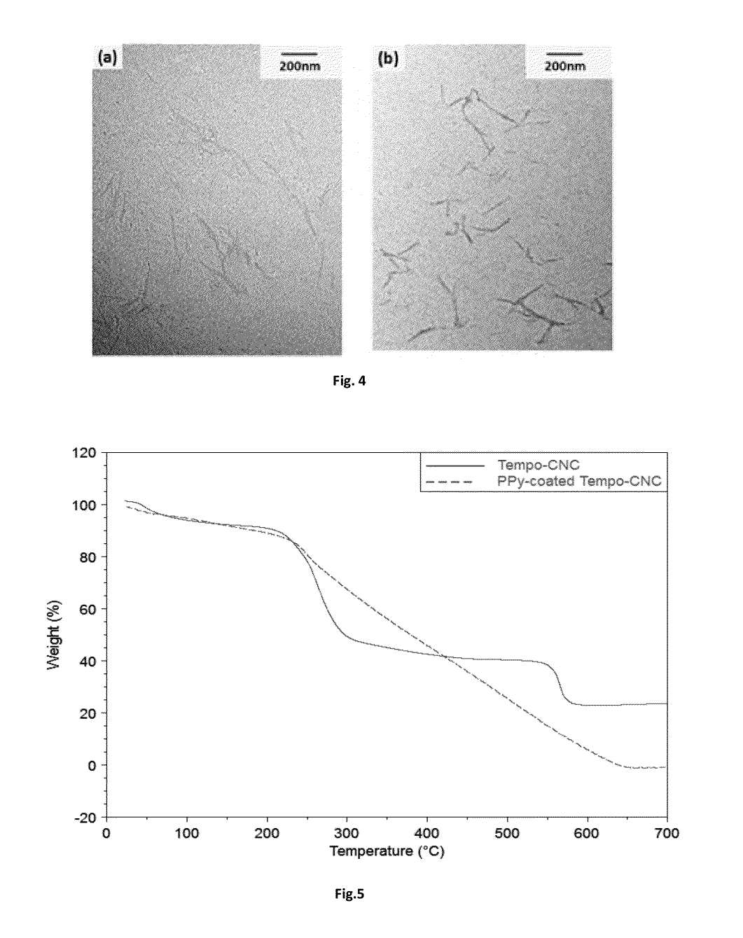

FIG. 3 shows the effect of pyrrole polymerization in the presence of the surfactant PSS. Both vials of the PPy/CNC suspension were kept undisturbed for 5 months. The one without adding PSS precipitated down but the other one with PSS remained homogenous and stable. While even for the precipitated PPy/CNC suspension, the suspension can be easily recovered to produce a uniform suspension upon shaking.

### EXAMPLE 3

### Characterizations of Conductive PPy/CNC Composite Material

FIG. 4 shows the transmission electron microscopic (TEM) image of the PPy/CNC using a Philips CM10 electron microscope. The TEM samples were prepared by depositing one drop of 0.01wt % sample dispersions onto a carbon coated TEM copper grid and dried at room temperature. From TEM pictures, the dimension and structural feature of CNC remained unchanged after coating with PPy.

FIG. 5 shows the thermal gravimetric analysis (TGA) test for Tempo-CNC, as well as the one coated with PPy. All samples were placed in inert ceramic crucibles and were heated from 25 to 700° C. at a heating rate of 10° C./min in the presence of a 20 mL/min flow of air. The PPy/CNC composite was thermally stable up to 250 degrees and displayed a high weight retention at high temperature (more than 40% up to 400 degrees). The weight loss in the first stage of PPy/CNC decreased by ⅓ compared with CNCs without coating. This is mainly due to the protection of polypyrrole and the effect was expected to be more prominent by increasing the polypyrrole coating.

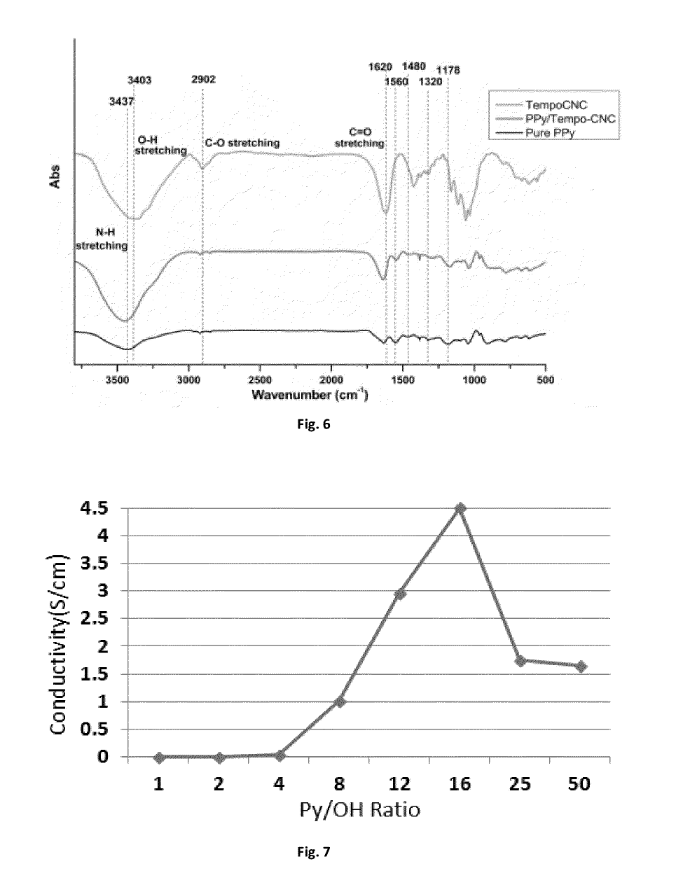

The FT-IR spectra of Tempo-oxidized CNCs, PPy and PPy/CNC are shown in FIG. 6. The FT-IR spectra were measured at room temperature using a PerkinElmer 1720 FT-IR spectrometer with a resolution of 4 cm⁻¹. The freeze-dried samples were mixed with KBr respectively and then compressed into pellets for measurement.

The characteristic bands due to newly formed carboxylic groups of the CNCs after Tempo-mediated oxidation were clearly observed in the FT-IR spectra. The IR bands at 3403, 2902, and 1620 cm⁻¹ were consistent with the O—H stretching, C—O stretching, C═O stretching in the Tempo-oxidized CNC, respectively. In case of PPy/CNC nanocomposite, all the carboxylic-related peaks were identified. The band at 3430 cm⁻¹ due to N—H stretching vibration gradually replaced the peak at 3403 cm⁻¹ for O—H stretching and the peak is shifted to a higher wavenumber compared with pure PPy. Moreover, the peaks at 2902 cm⁻¹, 1620 cm⁻¹ and 1061 cm⁻¹ are significantly quenched. These changes demonstrated the successful coating of polypyrrole on CNC surface confirming that the interfacial interaction of hydrogen bonding between carboxylic group of CNC and the amine group on PPy. Most of the characteristic peaks for pure PPy could be found in PPy/CNC nanocomposites, including the C—C ring fundamental vibration at 1560 cm⁻¹ (asymmetric ring stretching); band of C—N in-plane ring deformation at 1480 cm⁻¹ (symmetric ring stretching); C—H in-plane vibration at 1320 cm⁻¹; C—N stretching vibration appeared at 1178 cm⁻¹. Moreover, no new peak was observed for the CNC/PPy composite material besides peaks of pure CNC and PPy. This suggested that no new chemical bond was formed between CNC and PPy or no chemical reaction occurred in the process of forming the nanocomposites.

### EXAMPLE 4

### Effect of Conductive Polymer Coating on Electrochemical Properties

By adding different amounts of pyrrole monomer for polymerization, the extent of conductive coating on CNC could be tuned, resulting in PPy/CNCs with different electrochemical properties. Conductivity measurement was achieved with four-probe method. The freeze-dried bulk powder of PPy/CNC was pressed into pellet and the conductivity α in S/cm was calculated by:

α=(D/R)*(1/WT)

where D is the distance between the electrode, R is the measured resistivity of the pellet, W and T is the width and thickness of the pellet.

The conductivity change of PPy/CNC prepared at different molar ratio of pyrrole to the surface hydroxyl groups of CNC is shown in FIG. 7. The Py/OH ratios were varied at 1:1, 2:1, 4:1, 8:1, 12:1, 16:1, 25:1 and 50:1. The conductivity increased significantly from 0.0002 S/cm to 4.51 S/cm due to the increased PPy coating.

UV-Vis spectrum is a useful tool for detecting changes in the electronic structure of conductive polymers that is directly related to the conductivity change. FIG. 8 shows the UV spectra for PPy/CNC synthesized at different Py/OH molar ratios. Oxidized polypyrrole in its conducting states is known to have typical peaks at about 430 nm and 800 nm that are attributed to the transitions from valence band to the polaron/bipolaron bands formed upon doping. A most noticeable trend is the red-shift of the peak maxima from 413 to 490 nm and a blue-shift from 833 to 812 nm with increasing Py/OH ratio. This showed a decrease in bandgap between two excitation states of PPy due to longer conjugation length. However, the trend became obscure when the Py/OH was increased to 25 and 50. Both peaks were observed to broaden extensively and decrease in intensity, which suggested the existence of more disorders or defects introduced within the polymer chain. The changes in the peak position associating with the electronic structure of PPy agreed with the conductivity results for PPy/CNC.

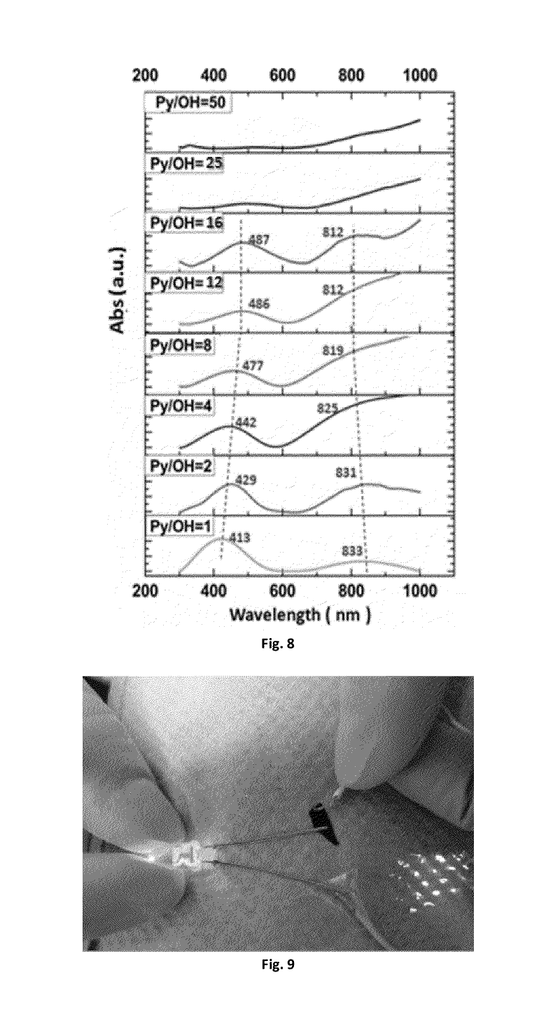

The combination of CNC and conducting polymers produced an enhanced electric conductivity of the conductive polymer associated with good mechanical properties. The high conductivity achieved with PPy/CNC will create new opportunities in a wide application fields, such as in electronic devices, printable circuit, etc. FIG. 9 shows an illustration of how conductive PPy/CNC (black sheet pressed from PPy/CNC powder) could conduct electricity in a circuit to light a bulb.

### EXAMPLE 5

### Immobilization of Silver with PPy/CNC

PPy has the ability to spontaneously reduce noble metals (e.g. Ag, Pt, Au etc.) from their salt at room temperature without the use of any added capping or dispersing agents (E. T. Kang, K. G. N., K. L. Tan, Surf. Interf. Anal. 1992, 19 (33); E. T. Kang, K. G. N., K. L. Tan, Adv. Polym. Sci. 1992, 106 (135)). Silver nanoparticles have received special attention in many areas like hygiene, bio-adhesives, implants, etc. due to its excellent antibacterial efficacy and low toxicity to human J. R. Morones, K. L. E., A. Camacho, K. Holt, J. B. Kouri, J. T. Ramirez, Nanotechnology 2005, 16 (2346); M. H. Youn, Y. M. L., H. J. Gwon, J. S. Park, S. J. An, Y. C. Nho, Macromol. Res. 2009, 17 (813); Y. Zhou, M. K., M. Asakawa, S. Dong, R. Kiyama, T. Shimizu, Adv. Mater 2009, 21 (1742). Recent investigations on the biocompatibility of PPy both in vivo and in vitro have also demonstrated its safety for being used for human health-related applications (Xiaodong Wang, X. G., Chunwai Yuan, Journal of biomedical materials research. Part A 2004, 68A (3), 411-422; Almira Ramanaviciene, A. K., Stasys Tautkus, Arunas Ramanavicius, Journal of Pharmacy and Pharmacology 2010, 59 (2), 311-315). Previous work has demonstrated that using various substrate for loading silver nanoparticles could greatly prevent silver aggregation and improve stability M. Lv, S. S., Y. He, Q. Huang, W. Hu, D. Li, Adv. Mater. 2010, 22 (5463). With the high surface area of PPy/CNCs prepared in this work, the immobilization of silver and the resulting anti-bacteria effect are expected to be more efficient. The Ag/PPy/CNC can also be formulated in a wide variety of ways (e.g. film, coating, or hydrogel) to suit different applications.

To prepare silver-decorated PPy/CNC, 100 mg freeze-dried PPy/CNC powder was dissolved into Milli-Q water to make a 2% wt suspension. Silver nitrate powder of 50 mg dissolved in 10 ml water was added to the suspension under magnetic stirring overnight. The resulting mixture was transferred to filtration to remove unreacted chemicals with water several times and freeze dried.

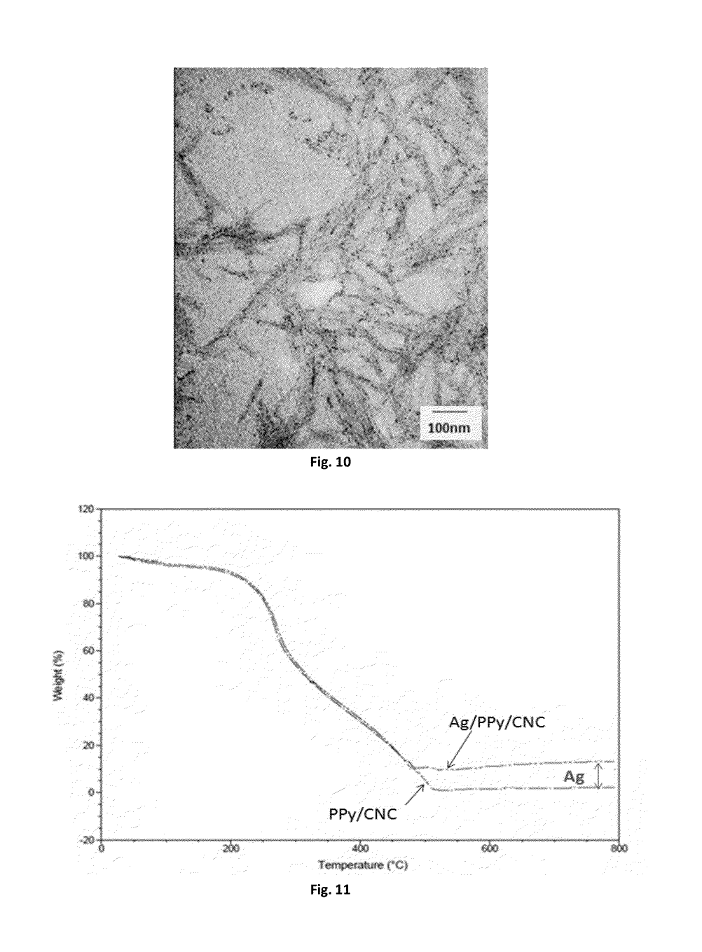

TEM results for the silver immobilized on PPy/CNC are shown in FIG. 10. It shows the uniform decoration of silver nanoparticles on the surface of PPy/CNC with a well-controlled size of less than 10 nm.

Metallic silver deposited on PPy/CNC can be quantitatively determined as a TGA residue after heating to 800° C. (FIG. 11). The difference residue of up to 11 mass % from the non-residue curve of PPy/CNC was associated with the silver within the composite.

The antibacterial activity was demonstrated by inhibition zone method against both E. coli (Gram negative bacteria) and Bacillus subtilis (Gram positive spore-forming bacteria) as the model bacteria. Cultures grown were Escherichia coli (a Gram negative bacteria) in nutrient broth and Bacillus subtilis (a Gram positive spore-forming bacteria) in tryptose phosphate broth. Cells were transferred from a slant into broth and cultured in an incubated shaker for 66 hrs at 37° C. Then, 0.3 mL was transferred to fresh broth and recultured for another 30 hrs. For preparing the testing plate, 0.2 mL bacteria was spread onto each modified agar disc that contained the corresponding broth medium. Small amount of sample powder (roughly 0.05 mg) of Tempo-CNC, PPy/CNC, Silver/PPy/CNC were then deposited over the bacteria. After placing in an incubation chamber for 24 hours at 37° C., the inhibition results in the Petri dish were observed and photographed.

The result of the inhibition test is shown in FIG. 12. Hazy areas indicated the bacterial growth, and the diffusion of silver from Ag/PPy/NCC surface to the agar will inhibit the bacteria growth along the path resulting in the transparent circles surrounding the composites. The results showed good inhibition effect of composite material of Ag/PPy/CNC for both gram positive and negative bacteria. In contrast, Tempo-oxidized CNC powder displayed no effect on the inhibition of bacteria and was quickly absorbed into the bacteria layer upon addition. PPy/CNC did not have inhibition effect either for Gram-positive bacteria, while interestingly, it did show some antibacterial effect for Gram-negative bacteria in all three of our test plates.

Spread plate count method was also performed to determine the antimicrobial effectiveness of Silver/PPy/CNC. In spread plate colony counts, cell suspension was mixed with differing concentrations of the Silver/PPy/CNC in liquid broth and incubated at 37° C. in a shaker rotating at 225 rpm. After 24 h of growth, 50 μL of each sample was spread across the surface of an agar plate in sterile conditions. Tests were conducted on Escherichia coli (E. coli), a gram negative bacteria on Silver/PPy/CNC at different concentrations in order to determine the minimum inhibition concentration—MIC (the concentrations at which the antimicrobial inhibits bacterial growth) and minimum bactericidal concentration—MBC (the concentration at which the antimicrobial completely prevents bacteria growth). They were calculated by testing decreasing concentrations of the antimicrobial agent using the spread plate colony counts until no antimicrobial activity was observed. The MIC value was determined from the concentration at which bacterial growth was less than the control. The MBC value was determined when there is at least 99% inhibition of bacterial growth.

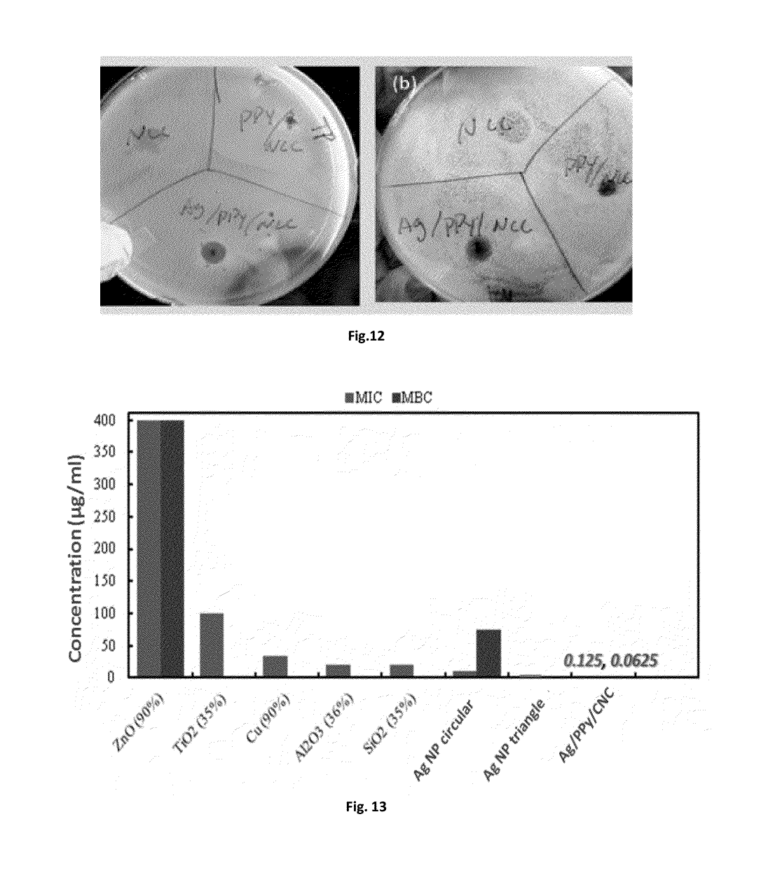

The MBC for Silver/PPy/CNC was determined to be 0.125 μg/ml and MIC is 0.0625 μg/ml. To further understand the results, the two measured numbers were compared to other existing antimicrobial reagent reported (FIG. 13): zinc oxide (S. Nai et al, J Mater Sci Mater Med. 2009, 20, S235-S241), titanium dioxide (A. Simon-Deckers et al., Environ Sci Technol. 2009, 43, 8423-8429), copper (K. Yoon et al., Sci Total Environ. 2007, 373, 572-575), silicon dioxide (W. Jiang et al., Environ Pollut. 2009, 157, 1619-1625) and silver nanoparticles (circular (I. Sondi et al., J Colloid Interf Sci. 2004, 275, 177-182) and triangle (S. Pal, Y. K. T., J. M. Song, Appl Environ Microbiol 2007, 73, 1712-1720)). Both the MBC and MIC for silver/PPy/CNC were significantly lower than other types of antimicrobial agent, revealing its great potential for anti-microbial applications.

### EXAMPLE 6

### Supercapacitor Electrode Fabrication

The potential of as-prepared PPy/CNC nanocomposite for supercapacitor application was explored by fabricating the sample as supercapacitor electrodes. Electrochemical properties of PPy/CNC were estimated by Cyclic Voltammetry (CV) measurement. All CV tests were conducted by an electrochemical station using three-electrode half-cell configuration with Ag/AgCl as the counter electrode and a saturated calomel electrode (SCE) as the reference electrode. The CV test was performed at different scan rates at 1, 10, and 100 mV/s within the potential window of −0.6 V to 0.4 V. The electrolyte of 0.5 M KCl was deoxygenated under a flow of N₂ for 30 min.

Prior to use, the glassy carbon (GC) electrodes was first polished with aqueous alumina (0.3 μm) slurries on felt polishing pads and rinsed with deionized water and acetone. The working electrode was prepared by dispersing PPy/CNC with mixed solution of H₂O/ethanol (V/V=1/1) to form a slurry (1 mg/ml). Then the slurry was cast onto the GC electrode (3 mm in diameter) twice with 10 ul per time and oven dried.

The capacitance obtained from CV curve was calculated as follows:

$${C}_{S} = \frac{\int idV}{2 \times m \times Δ V \times S}$$

where C_{S} is the specific capacitance, ∫idV is the integrated area of the CV curve, m is the mass of active material, ΔV is the potential range, and S is the scan rate.

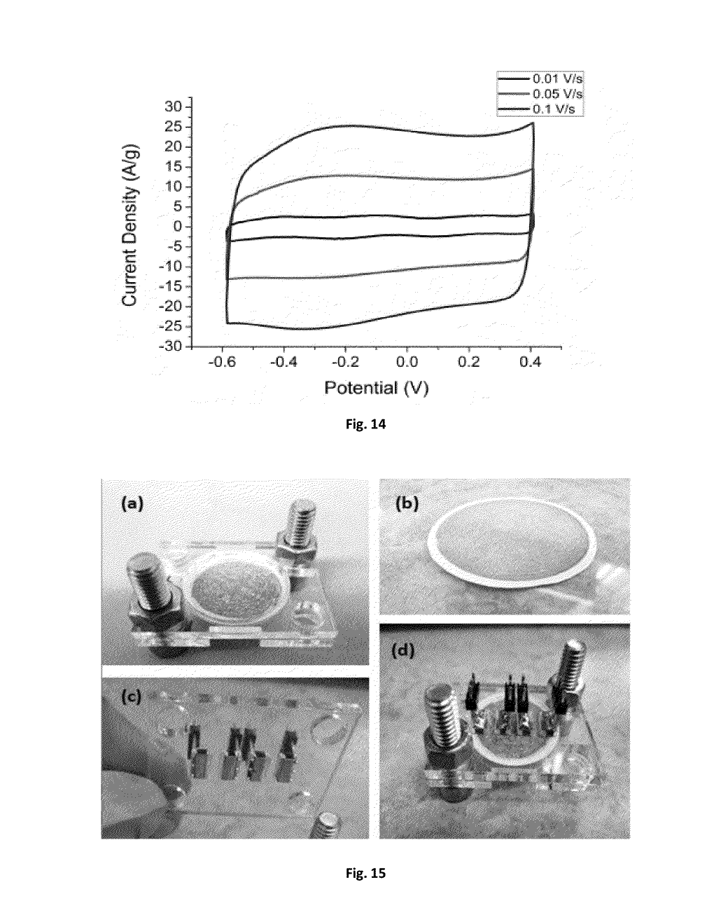

FIG. 14 shows the results from CV test on PPy/CNC sample (Py/OH=16) at various scan rates. The curves demonstrate beautiful rectangular shape, indicating its outstanding, reversible capacitive behavior. High capacitances of 239 F/g, 225 F/g, and 220 F/g were obtained at scan rates of 0.01, 0.05 and 0.1 V/s, respectively. Moreover, PPy/CNC retained more than 90% of their capacitance when the scan rate was increased from 0.01 to 0.1 V/s, suggesting an excellent charge transfer kinetics (i.e. polymers are thermodynamically stable and the redox transitions are faster than the scan speeds) between electrolyte and the active material of PPy/CNC as the electrode. The exceptional supercapacitor performance may be ascribed to the favorable polymerization of PPy that resulted in the ordered conductive coating around the CNC core and the strong interaction between the two.

It should be noted that, the combination of CNC and polypyrrole not only transformed a non-conducting CNC to a conducting CNC, but it also greatly enhanced the electrochemical properties of the polymer itself. The capacitance of pure polypyrrole synthesized under the same condition in the absence of CNC was only 90 F/g at the scan rate of 0.01 V/s, which was less than half compared to the capacitance of the composite material.

Within the supercapacitor field, carbon nanotube (single walled/multiwalled) and graphene have aroused tremendous interest in the past due to their super-conductive nature. Table 1 lists the capacitance of carbon nanotube and graphene based electrode materials from different studies as a comparison to this present invention.

TABLE 1
Capacitance measured in different studies on Single-walled carbon
nanotube (SWCT), Multi-walled carbon nanotube (MWCT), PPy-coated
MWCT, graphene sheet, nanocomposite of PPy and graphene.

| | | | | Specific | |
|---|---|---|---|---|---|
| No. | Material | Elecrolyte | Scan Rate | Capacitance | Referance |
| 1 | SWCT | 7.5M KOH | 100 mV/s | 180 F/g | An et al. 2001 |
| 2 | MWCT | 6M KOH | 10 mV/s | 135 F/g | Frackowiak et al. 2000 |
| 3 | PPy/MWCT | 1M H2SO4 | 10 mV/s | 170 F/g | Frackowiak et al. 2001 |
| 4 | Graphene | 1M Na2SO4 | 10 mV/s | 135 F/g | Y Li et al. 2011 |
| 5 | PPy/Graphene | 1M KCl | 10 mV/s | 223 F/g | Y. Han et al. 2010 |
| 6 | PPy/CNC | 0.5M KCl | 10 mV/s | 238 F/g | Current Work |
| | | | 100 mV/s | 220 F/g | |

(An et al. 2001): An, K. H.; Kim, W. S.; Park, Y. S.; Moon, J. M.; Bae, D. J.; Lim, S. C.; Lee, Y. S.; Lee, Y. H., Advanced Functional Materials 2001, 11 (5), 387-392;

(Frackowiak et al. 2000): Frackowiak, E.; Metenier, K.; Bertagna, V.; Beguin, F., Applied Physics Letters 2000, 77 (15), 2421-2423;

(Frackowiak et al. 2001):) Frackowiak E., J. K., Delpeuk S., Beguin F., J. Power Sources 2001, 822, 97-98.

(Y Li et al. 2011) Yueming Li, M. v. Z., Shirley Chiang, Ning Pana, Journal of Power Sources 2011, 196, 6003-6006.

Yongqin Han, B. D. a. X. Z., Journal of New Materials for Electrochemical Systems 2010, 13, 315-320.

(Y Han et al. 2010): Yongqin Han, B. D. a. X. Z., Journal of New Materials for Electrochemical Systems 2010, 13, 315-320.

The comparison from the table suggests that PPy/CNC is at least comparable to these costly, highly conductive materials. This illustrates the exciting potential of PPy/CNC for high performance, light and cheap energy storage devices.

### EXAMPLE 7

### Percolation in Conductive PPy/CNC Network (Towards Sensor Applications)

For applications like gas sensor, sensing material is generally deposited as a film onto the electrode. Wherein, the conductivity and the thickness of the film critically determine the effectiveness and sensitivity of the device. Significant effort has been made to miniaturize the external dimension of the sensing device (i.e. thickness of the film) and was demonstrated to be successful in increasing the sensitivity. This so-called external dimension effect was related to several mechanisms including gas diffusion, percolation theory, and the surface to volume ratio (J. Klober, M. L., and H. A. Schneider, Sens. Actuators B 1991, 3, 69-74; S. Altieri, L. H. T., and G. A. Sawatzky, Thin Solid Films 2001, 400, 9-15; N. Matsunaga, G. S., K. Shimanoe, and N. Yamazoe, Sens. Actuators B 2002, 83, 216-221). It is thus important to find a balance between conductivity and the thickness of the film (i.e. percolation concentration to form a conductive film).

CNC-based networks present outstanding potential for the development of gas sensors due to its 2-dimensional rod structure. A recent study showed that, an extremely low percolation threshold (5-fold decrease) of the polymer composite can be achieved by adding a small amount of cellulose whiskers into the composite (Evgeniy Tkalya, M. G., Wim Thielemans, Paul van der Schoot, Gijsbertus de With, and Cor Koning, ACS Macro Letters 2013, (2), 157-163). The high aspect ratio of cellulose whiskers can form a continuous pathway at a low concentration within the matrix, which benefits the electric conduction by further conductive polymer coverage over the cellulose template.

To determine the percolation concentration of the PPy/CNC, uniform PPy/CNC films were produced via an ultrafiltration setup (Millipore Stirred Ultrafiltration Cell Model 8010, 10 mL). A dilute suspension of PPy/CNCs was first poured into the cell over a nitrocellulose filtration membrane (Millipore, 100 nm). Then, a nitrogen gas was applied directly to the cell. As the water passed through the membrane as the filtrate out the cell, PPy/CNC particles larger than the pore size were retained on the membrane in the form a random interconnected network (FIG. 15b). The advantages of the current method in producing homogenous film are: first, it avoids the solvent evaporation effect (i.e. coffee ring effect) on the distribution of particles commonly seen in other film forming methods like dip casting; Second, during the filtration, denser regions act as a blockade to fluid flow, which promotes the tubes to accumulate to the rare region. The method used is simple, inexpensive, easy to adapt to large-scale application and allows film transfer to other surfaces by membrane dissolution (Wu, Z. C., Z.; Du, X.; Logan, J.; Sippel, J.; Nikolou, M.; Kamaras, K.; Reynolds, J.; Tanner, D.; Hebard, A.; Rinzler, A. Science 2004, 305, 1273).

Once the film was taken out of the cell, it is anchored between two acrylic glass plates for drying in air. (FIG. 15a) The centre of the upper acrylic glass was specially produced to make sure that the plate pins the edge of the membrane but not touch the film region. It is important to let the membrane dry flat since the tension arising from the curvature of the filtrate would disrupt the film (e.g. particle displacement, film cracking, etc.).

The surface resistance of the film was measured with four probe method using BK precision Model 889—Bench LCR/ESR Meter. Homemade electrode was developed (shown in FIG. 11c) with four parallel conductive copper plates aligned (3 mm in distance) on one side and the four connected electrode on the other side. Once the film dries, the top glass for anchoring the filtrate was removed and the electrode (copper side down) was placed over the film. The contact between PPy/CNC film and the electrode via copper plate greatly preserved the integrity of the film because the ultrathin film can be easily damaged if sharp tip was used.

The PPy/CNC suspension was prepared by dissolving 20 mg PPy/CNC dry powder in 100 ml water (0.2 mg/ml). The density of the film (weight/area) was easily controlled with high precision by varying the volume of the dilute suspension added to the filtration cell.

The density of the film (weight/area) can be calculated from:

C(f)=C(s)*V/A

where C(f) is the film density, C(s) is concentration of the dilute PPy/CNC suspension prepared, V is the volume of dilute PPy/CNC suspension used, A is the film area of the PPy/CNC network on the filtrate.

Sheet resistance was calculated from the expression:

R_{S}=R(W/D)

where Rₛ is the sheet resistance, R is the measured resistance, W is the width of the conductive plate in contact with the film, D is the distance between the electrodes.

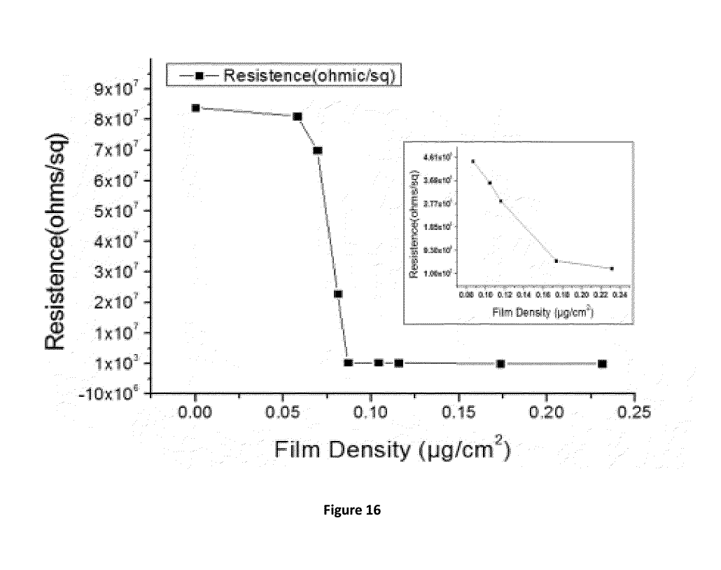

FIG. 16 shows the film resistivity plot against film density of PPy/CNC film. The sharp decrease in resistance indicating the onset of conduction was formed as low as 0.08 μg/cm². The small graph shows the zoom-in curve at the end of the percolation region and the resistance change gradually decreased once the continuous conductive path formed in the PPy/CNC network.

The result from percolation study of PPy/CNC film provided a guideline for making ultrathin yet effective film with high sensitivity for many sensor applications (gas sensor, humidity sensor, etc.). Moreover, a highly porous film formed by such PPy/CNC network greatly increased the surface area of PPy coating exposing to various analytes and promoted the interaction between the two.

While the disclosure has been described in connection with specific embodiments thereof, it is understood that it is capable of further modifications and that this application is intended to cover any variation, use, or adaptation of the disclosure following, in general, the principles of the disclosure and including such departures from the present disclosure that come within known, or customary practice within the art to which the disclosure pertains and as may be applied to the essential features hereinbefore set forth, and as follows in the scope of the appended claims.

1. A core-shell conductive polymer/cellulose nanocrystal composite comprising cellulose nanocrystals as the core, and intrinsically conductive polymer (ICP) coating as the shell.

2. The nanocrystal composite of claim 1, wherein said ICP is polypyrrole (PPy), polyaniline, polyindole, polythiophene, poly(3-methylthiophene, poly(N-methyl aniline) or poly(o-toluidine).

3. The nanocrystal composite of claim 1, wherein said ICP is polypyrrole.

4. The nanocrystal composite of claim 1, having a rod-like structure.

5. The nanocrystal composite of claim 1, having a length of about 200-400 nm and a diameter of about 10-20 nm.

6. A method of preparing the intrinsically conductive polymer/cellulose nanocrystal composite as described in claim 1, said method comprising steps 1) to 4) in order:
1) dispersing oxidized cellulose nanocrystals in a mixed solution of acid/alcohol;
2) mixing a monomer of said intrinsically conductive polymer with said oxidized cellulose nanocrystals;
3) polymerizing said monomer; and
4) isolating said conductive polymer/cellulose nanocrystal.

7. The method as defined in claim 6, wherein said monomer is a monomer producing, after polymerization, a polypyrrole (PPy), polyaniline, polyindole, polythiophene, poly(3-methylthiophene, poly(N-methyl aniline) or poly(o-toluidine).

8. The method of claim 6, wherein the molar ratio of monomer to the surface hydroxyl groups (OH) on CNC is from 1:1 to 50:1.

9. The method of claim 6, wherein a surfactant is added before the polymerization step 3).

10. The method of claim 6, wherein said oxidized cellulose nanocrystals is prepared by a step of oxidizing CNC with an oxidant.

11. The method of claim 6, wherein said solution of acid/alcohol is a solution of acid/ethanol.

12. The method of claim 6, wherein said acid is HClO₄.

13. The method of claim 6, wherein said solution of acid/alcohol is a solution having a volume ratio of HClO₄ to ethanol of 1:1.

14. The method of claim 6, wherein said monomer and said nanocrystals are mixed for a time duration of about one hour under controlled temperature.

15. (canceled)

16. The method of claim 6, wherein said polymerization is comprising a polymerization initiator.

17. (canceled)

18. (canceled)

19. A noble metal/ICP/cellulose nanocrystal hybrid material comprising:
the conductive polymer/cellulose nanocrystal composite as defined in claim 1, and
noble metal nanoparticles deposited on said composites, wherein said noble metal nanoparticles have a diameter of less than about 10 nm.

20. The hybrid material of claim 19, wherein said noble metal is Ag, Pt, Au or Cu.

21. A method to prepare a noble metal/ICP/cellulose nanocrystal hybrid material as described in claim 19, the method comprising:
dispersing the intrinsically conductive polymer/cellulose nanocrystal composite as defined in claim 1;
adding a noble metal salt to the dispersion and allowing reaction; and
recovering said noble metal/ICP/cellulose nanocrystal hybrid material.

22. The method of claim 21, wherein said noble metal salt is a silver salt.

23. (canceled)
